(19) United States
(12) Patent Application Publication
(10) Pub. No.: US 2013/0320703 A1
(43) Pub. Date: Dec. 5, 2013

(54) PROTECTIVE COVER SECURING APPARATUS

(71) Applicant: KEVIN JAGIELLO, WOODBRIDGE, VA (US)

(72) Inventor: KEVIN JAGIELLO, WOODBRIDGE, VA (US)

(21) Appl. No.: 13/487,710

(22) Filed: Jun. 4, 2012

(51) Int. Cl. B60R 11/00; B60J 11/04

(52) U.S. Cl. 296/136.01; 24/302; 24/301

(57) ABSTRACT

Disclosed are example devices configured to secure a cover to a motor vehicle. According to one example device a strap may be connected to at least two securing clips affixed to opposite ends of the strap. The securing clips are also affixed to the cover which is covering the motor vehicle. The straps may be affixed to various parts of the motor vehicle cover to secure the cover to the vehicle and the straps may be tightened and loosened around a vehicle wheel to securely maintain the position of the cover on the vehicle body.

### FIELD OF THE INVENTION

The invention is directed to a securing device that maintains a protective cover in a fixed position, and more particular, to a strap and affixing mechanism for maintaining a secure position of a protective cover to protect a motor vehicle or other outdoor apparatus from varying weather conditions.

### BACKGROUND OF THE INVENTION

Conventionally, motor vehicle covers and related covers for outdoor devices and machines may become loose and fall out of position exposing the outdoor device to the varying conditions of the weather. For example, a car cover cannot be too small or else it will be rendered useless since it cannot fit over the exterior surface of a car or other vehicle. However, car covers are expensive and there is a known desire to reuse them as often as possible even though they may be oversized with respect to a particular vehicle. An oversized car cover may work fine provided it does not fall off the motor vehicle due to wind or other forces of nature. However, there are no inexpensive, simple and reliable devices designed to secure a car cover in-place once it is placed over the exterior surface of a motor vehicle.

### SUMMARY OF THE INVENTION

One example embodiment may provide an apparatus configured to secure a cover to a motor vehicle. The apparatus may include a strap and at least two securing clips affixed to opposite ends of the strap, wherein the securing clips are also affixed to the cover which is covering the motor vehicle.

Another example embodiment of the present invention may include an apparatus configured to cover a motor vehicle. The apparatus may include a cover that encompasses the exterior surface of a motor vehicle, and a plurality of straps that are affixed to the cover in at least four different locations of the cover.

### BRIEF DESCRIPTION OF THE DRAWINGS

FIG. 1 illustrates a conventional motor vehicle cover according to example embodiments.

FIG. 2A illustrates a front view of a car cover and securing device according to example embodiments.

FIG. 2B illustrates a rear view of the car cover and securing device according to example embodiments.

FIG. 3A illustrates a first example securing device according to example embodiments.

FIG. 3B illustrates a second example securing device according to example embodiments.

FIG. 3C illustrates a third example securing device according to example embodiments.

FIG. 4A illustrates an example of a removable securing device with a length adjustable mechanism according to example embodiments.

FIG. 4B illustrates an example of a permanently affixed securing device with a length adjustable mechanism according to example embodiments.

FIG. 5A illustrates an example four-way alternative securing device according to another example embodiment.

FIG. 5B illustrates an example of the four-way alternative securing device in use according to another example embodiment.

FIG. 6A illustrates an example securing clip according to example embodiments.

FIG. 6B illustrates a sideways perspective example of the securing clip according to example embodiments.

### DETAILED DESCRIPTION OF THE INVENTION

It will be readily understood that the components of the present invention, as generally described and illustrated in the figures herein, may be arranged and designed in a wide variety of different configurations. Thus, the following detailed description of the embodiments of an apparatus, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

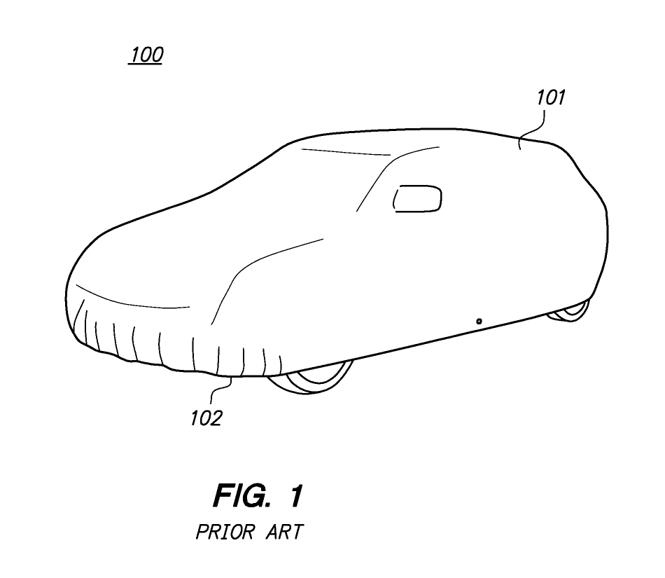

FIG. 1 illustrates a conventional motor vehicle cover according to example embodiments. Referring to FIG. 1, a car cover 100 is illustrated as having a full covering structure that protects the entire exterior surface of the motor vehicle except for the undercarriage. The cover 101 is generally a uniform material that is designed to protect the vehicle from rain, dirt and other debris. In general, the car cover may have some securing material that has some securing properties, such as, elasticity or high friction contact surfaces that better secure the car cover to the vehicle, such as elastic binding that causes the car cover to firmly grip the edge of the car surface or a rubber, plastic, or rubber/plastic compound that provides friction when pressed against the vehicle body to prevent the car cover from slipping off.

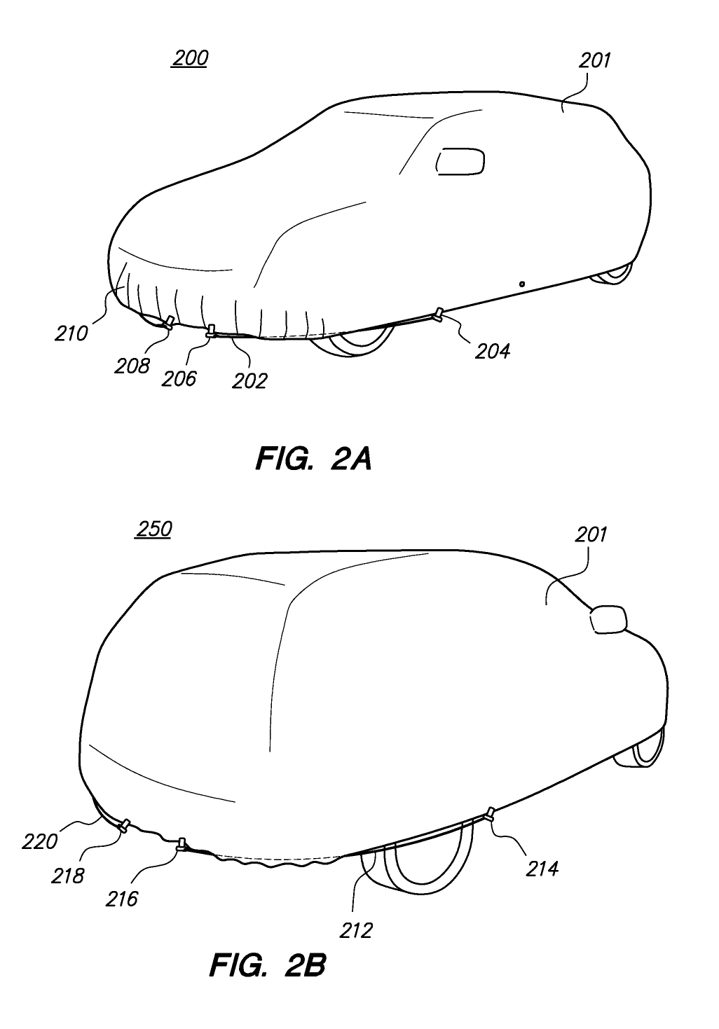

FIG. 2A illustrates a frontal or more specifically a frontal oblique view of the car cover and securing device configuration 200 which includes the cover 201 and securing devices, one of the securing devices may include a strap 202, and securing clips 204 and 206 according to example embodiments. Additionally shown is the right side securing device (with respect to the driver) which includes the front most securing clip 208, the strap 210 (hidden beneath the cover), and the rear clip (not shown).

Referring again to FIG. 2A, the securing straps 202 extend more than the length of each tire and secure the car cover firmly to the surface of the vehicle around the exterior outward facing portion of the wheel and tire. The securing device ideally allows the straps to be tightened in order to better secure the car cover to the vehicle. In an alternative embodiment, the strap may extend around the interior wall of the tire opposite the outward facing side of the tire and wheel that is gripped by the car cover so as to effectively wrap around the tire and be secured on the interior side of the tire by the securing device.

FIG. 2B illustrates a rear oblique view of the car cover and securing device 250 according to example embodiments which includes the cover 201, and securing devices which includes the right rear securing strap 212, and the right rear securing clips 214 and 216. Additionally illustrated is the left rear securing device which includes the left rear securing strap 220, the rear most left securing clip 218, and the front most rear left securing clip (not shown). The securing straps and clips may be secured to a bottom-most edge of the car cover and may be affixed at exactly an edge portion flush with the car cover edge or seem or approximately 1-3 inches up from the bottom of the car cover edge.

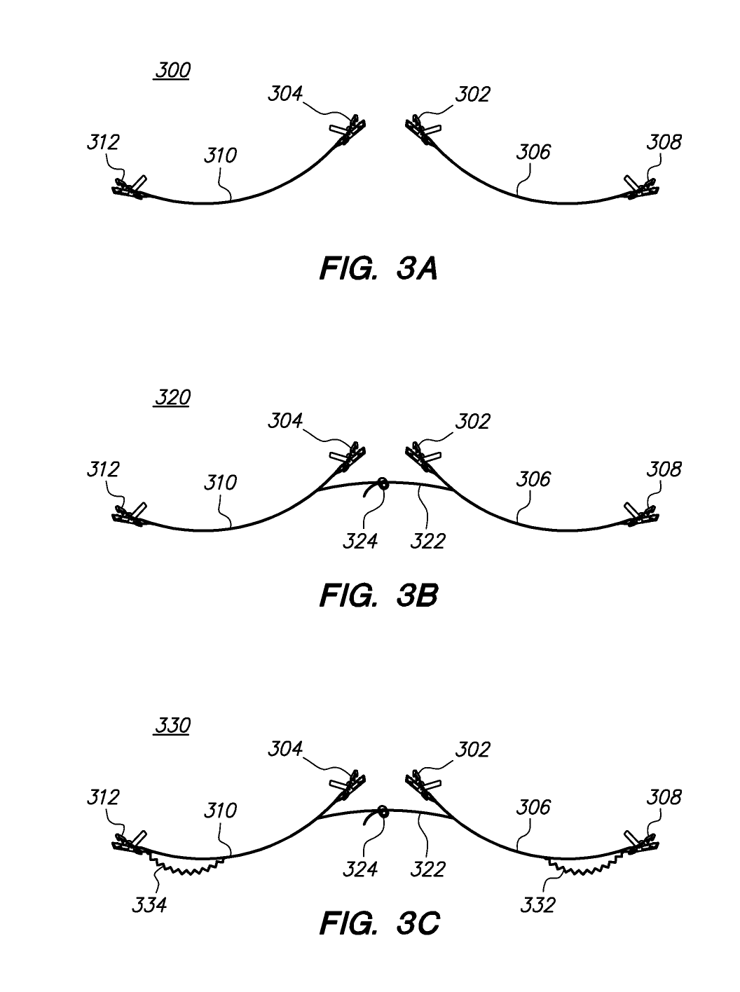

FIG. 3A illustrates a first example securing device 300 according to example embodiments. The securing device includes straps 306 and 310 which may be made of natural rope fibers such as manila hemp, hemp, linen, cotton, coir, jute, straw, and sisal, or any variety of other natural fibers, or synthetic fibers such as: polypropylene, nylon, polyesters (e.g. PET, LCP, HDPE, Veteran), polyethylene (e.g. Dynamo and Spectra), Barmaids (e.g. Tarpon, Technora and Kevlar) and acrylics (e.g. Dralon), any of the variety of co-polymer fibers, or any other variety of synthetic fiber rope material. The strap may alternatively be made of plastic, rubber or any other suitable type of material.

The clips 302, 304, 308, and 312 are preferably plastic or metal or any combination of both and are operable to allow the straps to be fed through the clip in an adjustable manner so that the strap can be tightened or loosened to allow the cover to be better secured to the vehicle body. In alternative embodiments, the clip may be made of other suitable hard materials. In yet other alternative embodiments, the clip may be made of any variation of adjustable Velcro straps, magnetically securing straps, or tying straps. The strap may have a small portion of slack folded and/or sewn near the clip that is longer than the body of the clip to ensure that the underside of the strap does not make contact with the car. For example, the strap may fold-over creating a material loop that extends between 0.5 and 2 inches beyond the clip to ensure the clip never rubs against the body of the car.

FIG. 3B illustrates another example of the securing device 320 according to example embodiments. This embodiment includes a binding strap 322 which binds the left strap to the right strap, and a length adjuster device 324 which allows the left strap and right strap to be tightened with respect to each other. The length adjuster may include any variation of clasps, Velcro or magnetic fasteners, or may include a knot which ties the straps together.

FIG. 3C illustrates a third example securing device 330 according to example embodiments. This embodiment includes elastic straps 332 and 334 which serve to further grip the contour of the vehicle body to better secure the cover to the vehicle. The elastic 334 is ideally only a small portion of the total length of the straps 306 and 310 to allow an easy way to stretch the strap near the point of securing the strap to the vehicle. For example, the elastic portion 334 may be one half, one third, one fourth or as little as one tenth of the total length of the strap 310.

According to example embodiments, the securing device may be configured to secure a cover to a motor vehicle. The securing device may include a strap and at least two securing clips affixed to opposite ends of the strap. The securing clips are also affixed to the cover which is covering the motor vehicle. The strap length may be greater than the diameter of a vehicle wheel of the motor vehicle but may also be less than twice the diameter and may be preferably anywhere between 12 inches and 96 inches. However, modifications to the length specified are permitted. The strap length may be adjustable by a length adjuster device. The strap may include two different materials one of which is inelastic and the other of which is elastic and stretchable (332 and 334 of FIG. 3C). The elastic portion of the strap may be less than one third of the total length of the strap, it may also be less than one fourth, one fifth or even as little as less than one tenth of the total strap length. This example provides a portion of the strap which is elastic and allows some flexibility for user convenience. The strap may include two straps that are joined together by a tether strap that is shorter than either of the two straps (FIGS. 3B and 3C).

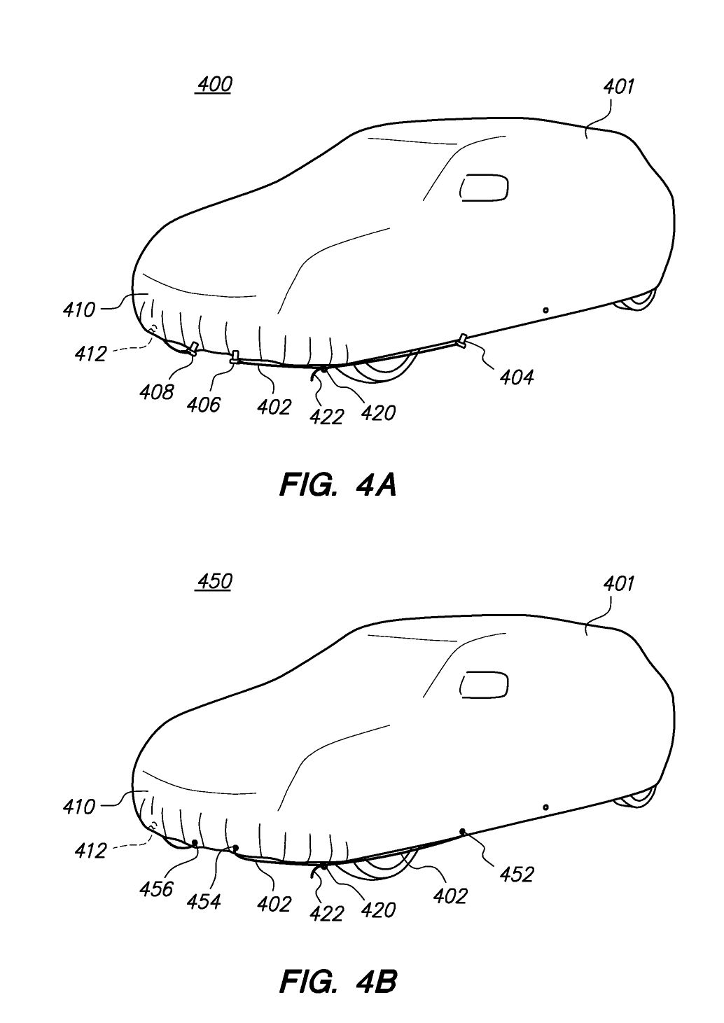

According to another example embodiment the a cover for a motor vehicle may include a cover that encompasses the exterior surface of a motor vehicle and a plurality of straps that are affixed to the cover in at least four different locations of the cover (FIGS. 4A and 4B). The plurality of straps are affixed to the cover in eight locations of the cover with two locations being affixed per strap. The plurality of straps are each connected to two fasteners located adjacent to an edge of the cover. Each of the at least two straps are made of any one of nylon, organic rope, plastic, and rubber. Each of the plurality of straps are adjustable in length.

FIG. 4A illustrates an example of a removable securing device and cover configuration 400 which includes a cover 401, and a securing device which includes a strap 402, and securing clips 404 and 406 which may be any type of securing clip previously discussed or any type of securing clip suitable for the example embodiments. The clips in this embodiment are removable from the cover 401. The current embodiment may include a length adjuster device 420 in the body of the strap 402 that may be of any type of adjuster previously discussed, or any type of adjuster suitable to realize the embodiments. The length adjuster 420 allows the strap 402 to be lengthened or shortened to better allow the cover to be secured to the vehicle body by allowing slack 422 to be fed through the length adjuster clip. Additionally shown, is the right front securing device which includes the strap 412, and securing clips 408 and 410.

FIG. 4B illustrates an example of a vehicle cover and permanently affixed securing device 450 with a length adjustable mechanism 422 according to example embodiments. This embodiment is similar to the previously mentioned embodiment of FIG. 4A with the exception that the securing clips 452, 454 and 456 are permanently affixed to the car cover 401. Ideally, the securing clips are sewn into the body of the car cover or are otherwise fastened to the car cover in a permanent fashion. The securing clips may be simply holes or eyelets through which the securing strap may be tied or otherwise fastened, or any type of clip previously discussed, or any type of clip suitable to realize the invention.

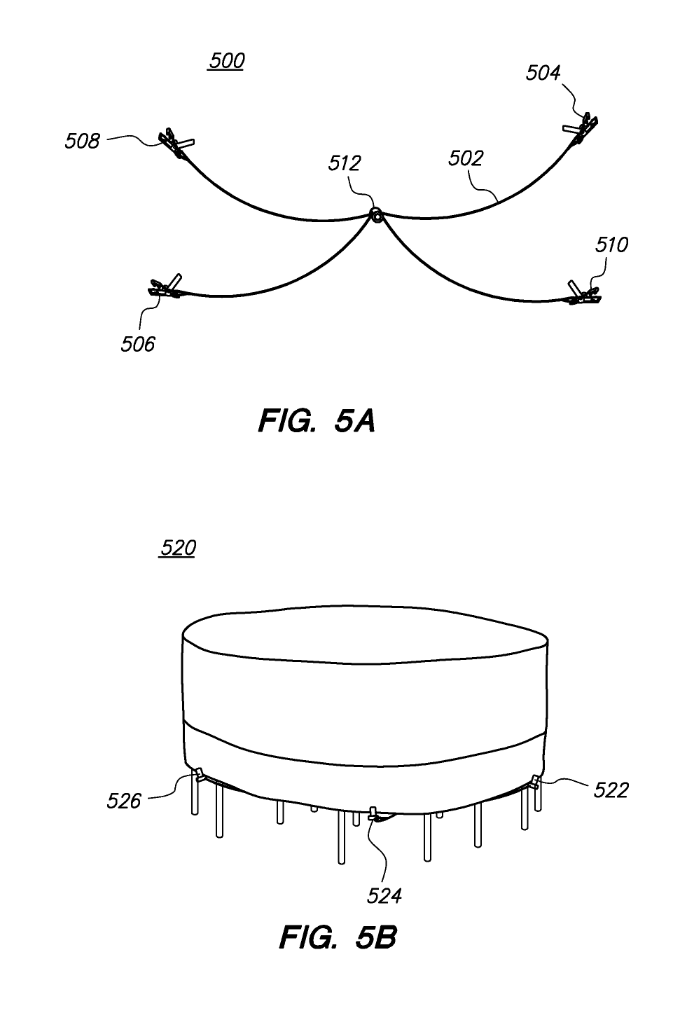

FIG. 5A illustrates an example four-way alternative securing device 500 according to another example embodiment. The straps 502 may be joined at an area other than the end of the straps through a 4-way joiner device 512. The 4-way joiner may simply be a knot, or may be any object made of metal, plastic, or any other suitable material to join the straps in such a configuration. In an example embodiment, the 4-way joiner serves to connect the straps under the vehicle carriage, and thereby provide additional securing of a cover onto the body of outdoor patio furniture or other outdoor apparatuses. The joiner device 512 is at a four-way cross-section of straps 502 having end securing clips 504, 506, 508 and 510.

FIG. 5B illustrates an example of the four-way alternative securing device 520 in use according to an example embodiment. The securing clips 522, 524, and 526 secure the straps onto the body of the covered object. In this embodiment, the object may be something other than a vehicle such as a piece of furniture. The last clip (not shown) would be secured to the far side of the cover.

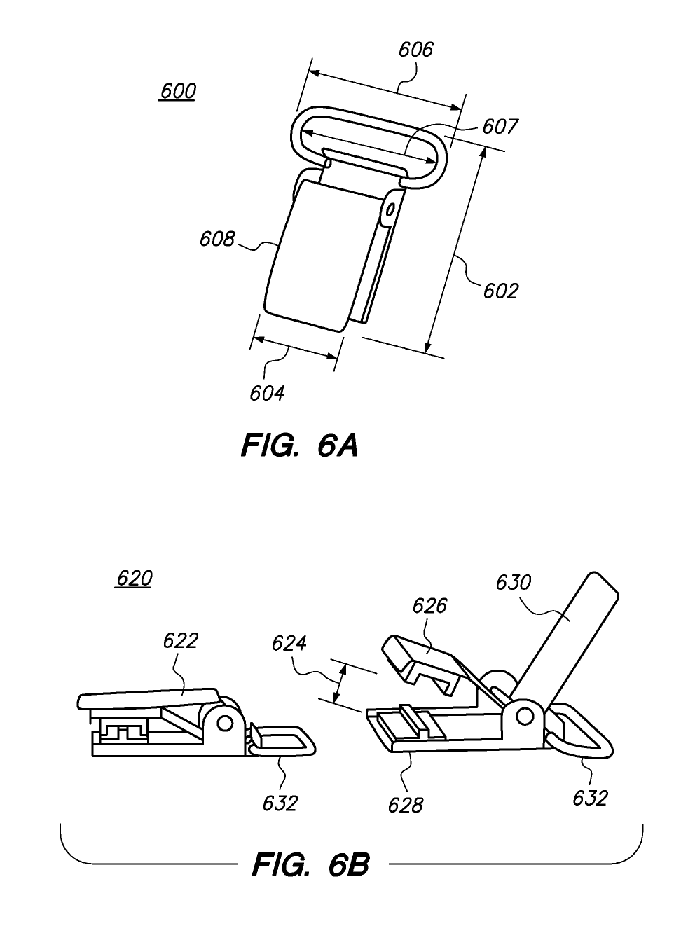

FIG. 6A illustrates an example securing clip 600 according to example embodiments. The length of the securing clip (approx. 1¾″) is shown in 602, the width of the securing clip (approx. ⅞″) is shown in 604. The eyelet through which the straps are secured is shown with its external dimensions 606 (approx. 1⅝″) and internal dimensions (approx. 1½″) 607. The clamping mechanism used to clamp down on the strap is shown in 608.

FIG. 6B illustrates a sideways perspective example of the securing clip 620 according to example embodiments. The eyelet through which the strap is fed is shown 632, the top length of the clamping mechanism (approx. 7/16″) is shown 622, the gap length the top part of the clamping mechanism 626 and the bottom part of the clamping mechanism 628 is (approx. 5/16″) shown 624, and the lever used to activate the clamping mechanism is shown in 630.

While preferred embodiments of the present invention have been described, it is to be understood that the embodiments described are illustrative only and the scope of the invention is to be defined solely by the appended claims when considered with a full range of equivalents and modifications thereto.

1. An apparatus configured to protect a motor vehicle, the apparatus comprising:
a cover that extends over a body of the motor vehicle, the cover comprising a front portion that extends over a front side of the motor vehicle, a rear portion that extends over a rear portion of the motor vehicle, and two side portions which extend over two sides of the motor vehicle;
at least four straps affixed to the cover at predetermined positions with a first strap affixed to the front portion and a first side portion, the second strap affixed to the front portion and a second side portion, the third strap affixed to the rear portion and the first side portion and the fourth strap affixed to the rear portion and the second side portion; and
at least two securing clips affixed to opposite ends of each of the four straps, wherein the securing clips provide a secure hold, which maintains a position of the four straps affixed to the cover such that each of the four straps respectively extend across at least one of an exterior surface area and an interior surface area of a corresponding different one of four respective vehicle wheels of the motor vehicle.

2. The apparatus of claim 1, wherein a strap length of each of the four straps is greater than a diameter of each of the four respective vehicle wheels of the motor vehicle.

3. The apparatus of claim 1, wherein a strap length of each of the four straps is adjustable via a length adjuster device.

4. The apparatus of claim 1, wherein each of the four straps comprises two different materials one of which is inelastic and the other of which is elastic and stretchable.

5. The apparatus of claim 4, wherein the elastic portion of each of the four straps is less than one third of a total length of each of the four straps.

6. The apparatus of claim 1, wherein each of the four straps comprises two separate strap portions that are joined together by a tether that is shorter than either of the two separate strap portions.

7. (canceled)

8. The apparatus of claim 1, wherein the four straps are affixed to the cover in eight locations of the cover with two locations being affixed on the cover per strap.

9. The apparatus of claim 8, wherein the four straps are each connected to two fasteners located adjacent to an edge of the cover.

10. The apparatus of claim 8, wherein each of the four straps are made of any one of: nylon, organic rope, plastic, and rubber.

11. The apparatus of claim 8, wherein each of the four straps is adjustable in length.
